(19) United States
(12) Patent Application Publication
(10) Pub. No.: US 2026/0252450 A1
(43) Pub. Date: Aug. 27, 2026

(54) EXAM DEVICE

(71) Applicant: NTT , Inc., Tokyo (JP)

(72) Inventors: Tatsuya TAKEMURA, Tokyo (JP); Hiroshi KURAKAMI, Tokyo (JP)

(73) Assignee: NTT , Inc., Tokyo (JP)

(21) Appl. No.: 19/127,129

(22) PCT Filed: Nov. 8, 2022
(86) PCT No.: PCT/JP2022/041529

§ 371 Date: May 5, 2025

(51) Int. Cl. G06F 11/22; H04L 43/50

(52) U.S. Cl. CPC G06F 11/2273; G06F 11/221; H04L 43/50

(57) ABSTRACT

A testing device includes: an access examination unit that examines an access method for a plurality of devices existing in a test target network; a test scenario unit that generates a test packet on the basis of an examination result of the access method and a scenario in which a procedure related to generation of the test packet is described; a transmission unit that transmits the test packet; and a log analysis unit that collects a log from a device to which the test packet is transmitted among the plurality of devices existing in the test target network and analyzes the collected log.

### TECHNICAL FIELD

The present invention relates to a testing device.

### BACKGROUND ART

Conventionally, a method of transmitting a packet for applying a load to a device and performing a packet load test has been proposed (see, for example, Non Patent Literature 1). In addition, Patent Literature 1 proposes a method in which a testing device performs a packet load test by transmitting a test packet for increasing a processing load to a device protected by a security system.

### CITATION LIST

### Patent Literature

Patent Literature 1: JP 2020-129736 A

### Non Patent Literature

Non Patent Literature 1: IXIA, “Denial of Service (DOS) Testing” [online], [searched on October 24, 2022], Internet <URL: https://support.ixiacom.com/sites/default/files/resources/test-plan/dos_0.pdf>

### SUMMARY OF INVENTION

### Technical Problem

In order to test resistance to a denial-of-service attack on a plurality of devices in a network, such as a carpet bombing attack, whose frequency has increased in recent years, it is required to transmit a test packet to an upper layer of a plurality of devices reachable from the outside. For example, the upper layer is a layer of layer 5 or higher.

However, in the conventional methods described above, there is a problem that, in a case where a test of resistance to a denial-of-service attack is performed for an upper layer, a destination of a test packet is limited to one in a test target network.

In the present situation, in order to test resistance to a denial-of-service attack on an upper layer of a plurality of devices, it is necessary to prepare a plurality of testing devices after checking a plurality of devices reachable from the outside and access information in advance, and create test scenarios for the plurality of testing devices.

The present invention has been made in view of the above, and an object of the present invention is to provide a testing device capable of transmitting a test packet to an upper layer of a plurality of devices and performing a test of resistance to a denial-of-service attack.

### Solution to Problem

In order to solve the above-described problem and achieve the object, a testing device includes: an access examination unit that examines an access method for a plurality of devices existing in a test target network; a test scenario unit that generates a test packet on the basis of an examination result of the access method and a scenario in which a procedure related to generation of the test packet is described; a transmission unit that transmits the test packet; and a log analysis unit that collects a log from a device to which the test packet is transmitted among the plurality of devices existing in the test target network and analyzes the collected log.

### Advantageous Effects of Invention

According to the present invention, it is possible to transmit a test packet to an upper layer of a plurality of devices and to perform a test of resistance to a denial-of-service attack.

### BRIEF DESCRIPTION OF DRAWINGS

FIG. 1 is a diagram illustrating an example of a configuration of a network including a testing device according to the present embodiment.

FIG. 2 is a functional block diagram illustrating a configuration of the testing device according to the present embodiment.

FIG. 3 is a flowchart illustrating a processing procedure of the testing device according to the present embodiment.

FIG. 4 is a flowchart illustrating a processing procedure of test packet generation processing.

FIG. 5 is a diagram illustrating an example of a computer that executes a test program.

### DESCRIPTION OF EMBODIMENTS

Hereinafter, an embodiment of a testing device disclosed in the present application will be described in detail with reference to the drawings. Note that the present invention is not limited to the present embodiment.

### EMBODIMENT

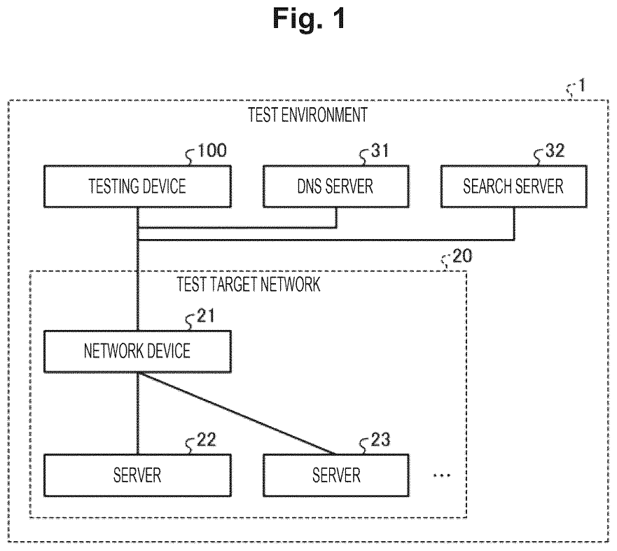

FIG. 1 is a diagram illustrating an example of a configuration of a network including a testing device according to the present embodiment. As illustrated in FIG. 1, a test environment 1 includes a testing device 100, a domain name system (DNS) server 31, a search server 32, and a test target network 20.

The test target network 20 includes a network device 21 and servers 22 and 23. The test target network 20 may include a server other than the servers 22 and 23, which is not illustrated in FIG. 1.

The testing device 100, the DNS server 31, the search server 32, and the test target network 20 included in the test environment 1 are connected by any type of communication network such as a wired or wireless local area network (LAN) or virtual private network (VPN).

The network device 21 connects the testing device 100 and the servers 22 and 23 in the test target network 20. The network device 21 is a router, a firewall, or the like.

In a case of accepting an access, the servers 22 and 23 provide services to an access source device.

The DNS server 31 provides a mechanism for translating a domain name and an Internet protocol (IP) address. In the present embodiment, in a case of receiving information on an IP address from the testing device 100, the DNS server 31 executes reverse DNS lookup, extracts a domain name corresponding to the IP address, and transmits information on the extracted domain name to the testing device 100.

In a case of accepting designation of text data as a search target, the search server 32 extracts a uniform resource locator (URL) accessible by Hypertext Transfer Protocol (HTTP). In the present embodiment, in a case of receiving information on a domain name from the testing device 100, the search server 32 extracts an HTTP accessible URL including a subdomain name of the domain name, and transmits information on the extracted URL to the

### Testing Device 100.

The testing device 100 is a device that transmits a test packet to devices such as the servers 22 and 23 included in the test target network 20 and executes a security tolerance test against a denial-of-service attack or the like. The testing device 100 receives a packet transmitted from the test target network 20, and monitors the load status of each device (the servers 22 and 23 and the like) included in the test target network 20.

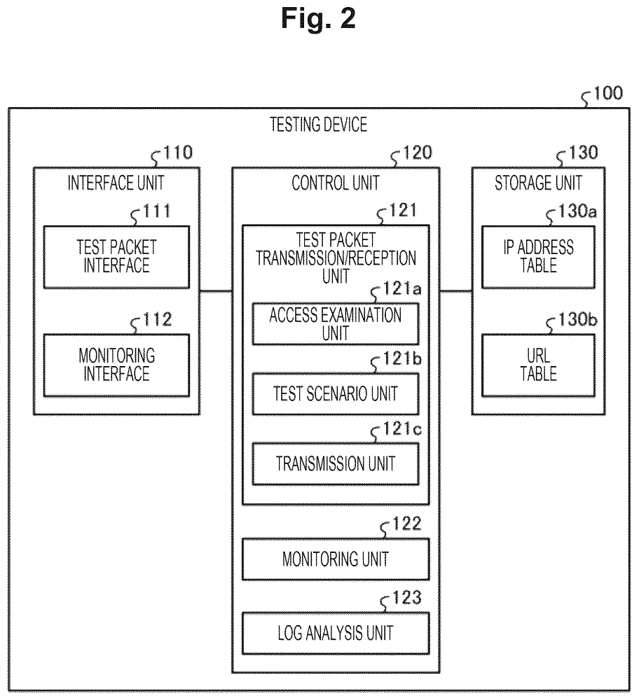

Next, a configuration example of the testing device 100 illustrated in FIG. 1 will be described. FIG. 2 is a functional block diagram illustrating a configuration of the testing device according to the present embodiment. As illustrated in FIG. 2, the testing device 100 includes an interface unit 110, a control unit 120, and a storage unit 130.

The interface unit 110 is an interface that controls communication with other devices. For example, the interface unit 110 transmits and receives packets to and from other devices via a network. The interface unit 110 is a network interface such as a LAN card.

The interface unit 110 includes a test packet interface 111 and a monitoring interface 112.

The test packet interface 111 transmits and receives packets accompanying the execution of a function of transmitting and receiving test packets. The monitoring interface 112 transmits and receives packets accompanying the execution of a monitoring unit 122 described later.

The control unit 120 controls the entire testing device 100. The control unit 120 includes a test packet transmission/reception unit 121, the monitoring unit 122, and a log analysis unit 123. The control unit 120 is a processor such as a central processing unit (CPU) or a micro processing unit (MPU).

The test packet transmission/reception unit 121 transmits a test packet to devices such as the servers 22 and 23 included in the test target network 20, and executes a security tolerance test against a denial-of-service attack or the like. The test packet transmission/reception unit 121 includes an access examination unit 121a, a test scenario unit 121b, and a transmission unit 121c.

The access examination unit 121a is a processing unit that examines access methods for the servers 22 and 23 and other servers (not illustrated) included in the test target network 20. For example, the access examination unit 121a executes the first examination processing and the second examination processing.

The “first examination processing” executed by the access examination unit 121a will be described. The access examination unit 121a examines whether it is possible to establish a transmission control protocol (TCP) connection by using a designated destination port number for all IP addresses included in an IP address range of the test target network 20. Information on the IP address range of the test target network 20 is set in the storage unit 130 in advance. The designated destination port number is set to “No. 443” and “No. 80”, but are not limited thereto.

The access examination unit 121a performs a three-way handshake to examine whether it is possible to establish a TCP connection. Specifically, the access examination unit 121a transmits a TCP SYN packet in which the designated destination port number is set to all the IP addresses of the test target network 20. The access examination unit 121a records a destination IP address from which an SYN/ACK response has been returned in an IP address table 130a of the storage unit 130 as an IP address accessible target.

Each of the IP addresses recorded in the IP address table 130a is an IP address that can establish a TCP connection using the designated destination port number. Using such IP addresses makes it possible to test resistance to a denial-of-service attack to a plurality of destination IP addresses using TCP. In addition, in a case where No. 443 and No. 80 are used as destination port numbers, it is possible to test resistance to a denial-of-service attack on IP addresses of a plurality of destinations in which the IP addresses are entered instead of fully qualified domain names (FQDNs) for web sites.

Next, the “second examination processing” executed by the access examination unit 121a will be described. The access examination unit 121a searches the entire IP address range of the test target network 20 for a URL.

Specifically, the access examination unit 121a transmits information on the IP addresses of the entire IP address range of the test target network 20 to the DNS server 31, and receives each of domain names of the IP addresses of the entire IP address range of the test target network 20 from the DNS server 31. The access examination unit 121a transmits information on the received domain name to the search server 32, and receives an HTTP accessible URL including a subdomain name of the domain name from the search server 32.

The access examination unit 121a accesses the received URL and receives a response packet from the access destination. In a case where the IP address of the response packet (the IP address of the source) is included in the IP address range of the test target network 20, the access examination unit 121a records the URL (the URL including an FQDN) used for the access in a URL table 130b of the storage unit 130 as a URL accessible target. The access examination unit 121a repeatedly executes the above processing on a plurality of HTTP accessible URLs each including a subdomain name of a domain name.

In this manner, the access examination unit 121a examines whether it is possible to perform HTTP access to the servers 22 and 23 of the test target network 20 using a URL including an FQDN. As a result, even in a case where a web site is set not to respond to an HTTP request including an IP address in a URL, an HTTP access including an FQDN in the URL makes it possible to test resistance to a denial-of-service attack on IP addresses of a plurality of destinations.

The test scenario unit 121b establishes a TCP connection to the test target network 20 with the designated destination port number on the basis of the examination results of the access examination unit 121a and a preset scenario, and generates a test packet. The scenario is information in which a procedure for generating a test packet is described by a script or the like.

According to the examination results of the access examination unit 121a, the IP address table 130a records IP addresses that can establish a TCP connection and are IP address accessible targets in the IP address range of the test target network 20. The test scenario unit 121b establishes a TCP connection to an IP address recorded in the IP address table 130a, and then generates an HTTP request packet for performing a test of resistance to a denial-of-service attack using HTTP. In the following description, an HTTP request packet for performing a test of resistance to a denial-of-service attack using HTTP is appropriately referred to as a “test packet”.

In a case where the servers 22 and 23 of the test target network 20 are web sites and are IP address accessible web sites, the test scenario unit 121b generates a test packet for the web sites by setting IP addresses instead of FQDNs in an HTTP request packet.

Incidentally, in a case where the servers 22 and 23 of the test target network 20 are web sites and are URL accessible targets based on the URL table 130b, the test scenario unit 121b generates a test packet for the web sites using URLs including FQDNs (URLs recorded in the URL table 130b) in an HTTP request packet.

The transmission unit 121c transmits the test packets generated by the test scenario unit 121b to the servers 22 and 23 (or another server) of the test target network 20. For example, the transmission unit 121c increases a processing load of the servers 22 and 23 by gradually increasing the number of test packets to be transmitted on the basis of the scenario set in the test scenario unit 121b.

In a case of transmitting a test packet, the transmission unit 121c may transmit a packet generated by operation of a web browser to the same device as the device to which the test packet is transmitted. Assume that the packet generated by operation of the web browser is recorded in advance in the storage unit 130.

The monitoring unit 122 monitors the packet filtering status and the processing load status of the servers 22 and 23. The monitoring unit 122 monitors the number of test packets, the byte amount, and the number of sessions per unit time in units of source IP addresses, and a response packet from the test target network 20 as monitoring of the packet filtering status, and specifies a source IP address that comes to receive no response packet even if a test packet is transmitted, although other source IP address test packets receive response packets. The monitoring unit 122 records, as packet filtering thresholds of the test target network 20, the number of test packets, the byte amount, the number of sessions, and the time stamp that are transmitted at the time immediately before the source IP address comes to receive no response packet, and notifies the control unit 120 of these values.

The log analysis unit 123 collects, after the test, logs from each device such as the servers 22 and 23 on the path through which the test packets have flowed, which includes the test target network 20, and examines a response of each device to the test packets, thereby analyzing whether the processing load has increased and whether a normal packet has been involved and discarded. The log analysis unit 123 may record the analysis results in the storage unit 130.

For example, in a case where a time from reception of a packet to transmission of a response packet is equal to or longer than a threshold on the basis of the logs, the log analysis unit 123 specifies that the processing load of the servers 22 and 23 and the like through which the test packets have flowed has increased. The log analysis unit 123 holds information for identifying a normal packet and the like, and specifies whether a history of discarding the normal packet is described in the logs.

The storage unit 130 stores various types of information used in a case where the control unit 120 executes processing. For example, the storage unit 130 stores the above-described IP address table 130a, URL table 130b, and the like. The storage unit 130 is implemented by, for example, a semiconductor memory element such as a flash memory or a storage device such as a hard disk.

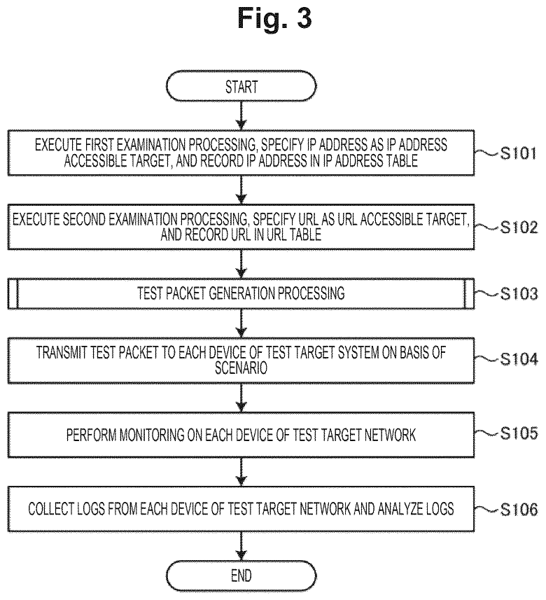

Next, an example of a processing procedure of the testing device 100 according to the present embodiment will be described. FIG. 3 is a flowchart illustrating the processing procedure of the testing device according to the present embodiment. As illustrated in FIG. 3, the access examination unit 121a of the testing device 100 executes the first examination processing, specifies an IP address as an IP address accessible target, and records the IP address in the IP address table 130a (step S101).

The access examination unit 121a executes the second examination processing, specifies a URL as a URL accessible target, and records the URL in the URL table 130b (step S102).

The test scenario unit 121b of the testing device 100 executes test packet generation processing (step S103). The transmission unit 121c of the testing device 100 transmits a test packet to each device of the test target network 20 on the basis of a scenario (step S104).

The monitoring unit 122 of the testing device 100 performs monitoring on each device of the test target network 20 (step S105). The log analysis unit 123 of the testing device 100 collects logs from each device of the test target network 20 and analyzes the logs (step S106).

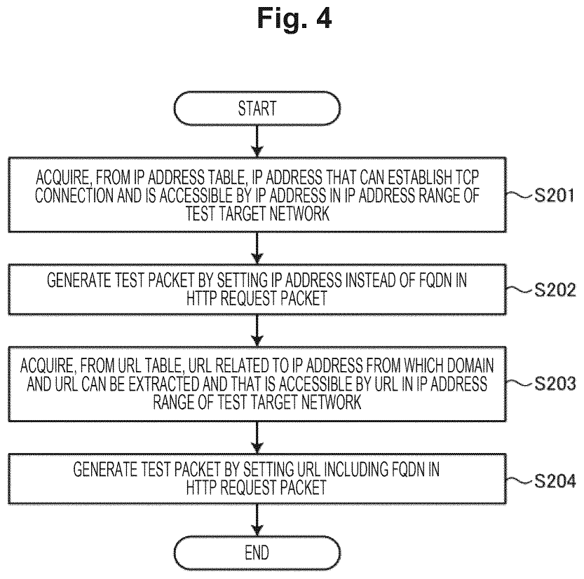

Next, a processing procedure of the test packet generation processing illustrated in step S103 of FIG. 3 will be described. FIG. 4 is a flowchart illustrating the processing procedure of the test packet generation processing. The processing procedure of FIG. 4 is processing based on a preset scenario. The test scenario unit 121b of the testing device 100 acquires, from the IP address table 130a, an IP address that can establish a TCP connection and is accessible by an IP address in the IP address range of the test target network 20 (step S201).

The test scenario unit 121b generates a test packet by setting an IP address instead of an FQDN in an HTTP request packet (step S202).

The test scenario unit 121b acquires, from the URL table 130b, a URL related to an IP address from which a domain and a URL can be extracted and that is accessible by an URL in the IP address range of the test target network 20 (step S203).

The test scenario unit 121b generates a test packet by setting the URL including an FQDN in an HTTP request packet (step S204).

Next, effects of the testing device 100 according to the present embodiment will be described. The testing device 100 examines an access method for a plurality of devices existing in the test target network 20, generates a test packet on the basis of an examination result of the access method and a scenario in which a procedure related to generation of the test packet is described, transmits the test packet, collects a log from a device to which the test packet is transmitted among the plurality of devices existing in the test target network, and analyzes the collected log. As a result, it is possible to transmit the test packet to an upper layer of the plurality of devices and to perform a test of resistance to a denial-of-service attack.

The testing device 100 performs processing of examining whether it is possible to establish a TCP connection by performing a three-way handshake on IP addresses included in an IP address range of the test target network 20, and recording an IP address capable of establishing the TCP connection in the IP address table 130a. In addition, the testing device 100 establishes a TCP connection on the basis of an IP address recorded in the IP address table 130a and a predetermined destination port number, and generates the test packet by setting the IP address recorded in the IP address table 130a in an HTTP request packet. £ In this manner, using IP addresses in the IP address table 130a makes it possible to test resistance to a denial-of-service attack to a plurality of destination IP addresses using TCP. In addition, in a case where No. 443 and No. 80 are used as destination port numbers, it is possible to test resistance to a denial-of-service attack on IP addresses of a plurality of destinations in which the IP addresses are entered instead of FQDNs for web sites.

The testing device 100 performs processing of extracting a URL corresponding to a domain name of an IP address included in the IP address range of the test target network 20, and recording the extracted URL in the URL table 130b in a case where an IP address of a response packet at the time of accessing the extracted URL is included in the IP address range of the test target network 20. In addition, in a case where URLs of sites of the plurality of devices existing in the test target network 20 are recorded in the URL table 130b, the testing device 100 generates the test packet by setting the URLs recorded in the URL table 130b in the HTTP request packet. As a result, even in a case where a web site is set not to respond to an HTTP request including an IP address in a URL, an HTTP access including an FQDN in the URL makes it possible to test resistance to a denial-of-service attack on IP addresses of a plurality of destinations.

The testing device 100 transmits the test packet and a packet generated by operation of a web browser to the test target network 20. As a result, it is possible to test a reaction of each device of the test target network 20 in a case where operation of the web browser is added in addition to the test packet.

The testing device 100 analyzes the presence or absence of an increase in a processing load of the device to which the test packet is transmitted and the presence of absence of discarding of a normal packet on the basis of the log collected from the test target network 20. As a result, it is possible to obtain an analysis result of a test of resistance to a denial-of-service attack.

Incidentally, in a case where the server 22 or the server 23 is a server other than a web server such as a DNS server, or in a case where the network device 21 is examined, the testing device 100 transmits a denial-of-service attack packet and a normal packet according to a protocol and an application serviced by the test target devices. As a result, it is possible to advance a security tolerance examination and a bottleneck examination of all the test target devices in the test target network 20.

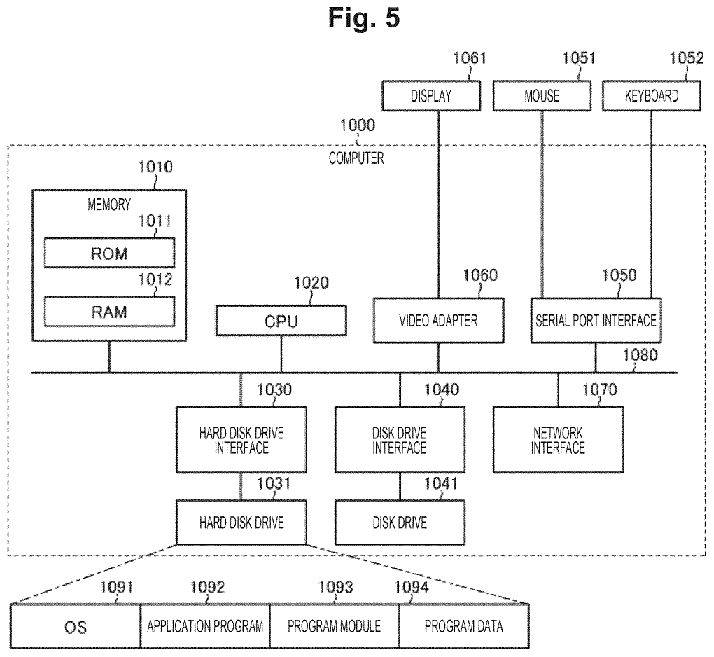

Next, an example of a computer that executes a test program will be described. FIG. 5 is a diagram illustrating an example of a computer that executes the test program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disk is inserted into the disk drive 1041. The serial port interface 1050 is connected to, for example, a mouse 1051 and a keyboard 1052. The video adapter 1060 is connected to, for example, a display 1061.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

Furthermore, the test program is stored in the hard disk drive 1031 as, for example, the program module 1093 in which commands executed by the computer 1000 are described. Specifically, the program module 1093 in which processing executed by the test packet transmission/reception unit 121, the monitoring unit 122, and the log analysis unit 123 described in the above embodiment is described is stored in the hard disk drive 1031.

In addition, data used for information processing performed by the test program is stored as the program data 1094 in, for example, the hard disk drive 1031. The CPU 1020 then reads the program module 1093 and the program data 1094 stored in the hard disk drive 1031 to the RAM 1012 as necessary, and executes each procedure described above.

Note that the program module 1093 and the program data 1094 related to the test program are not limited to being stored in the hard disk drive 1031, and may be stored in, for example, a removable storage medium and read by the CPU 1020 via the disk drive 1041 or the like. Alternatively, the program module 1093 and the program data 1094 related to the test program may be stored in another computer connected via a network such as a LAN or a wide area network (WAN) and read by the CPU 1020 via the network interface 1070.

Although the embodiment to which the invention made by the present inventor is applied has been described above, the present invention is not limited by the description and the drawings according to the present embodiment, which constitute a part of the disclosure of the present invention. That is, other embodiments, examples, operation techniques, and the like made by those skilled in the art on the basis of the present embodiment are all included in the scope of the present invention.

### REFERENCE SIGNS LIST

1 Test environment
20 Test target network
21 Network device
22, 23 Server
31 DNS server
32 Search server
100 Testing device
110 Interface unit
111 Test packet interface
112 Monitoring interface
120 Control unit
121 Test packet transmission/reception unit
121a Access examination unit
121b Test scenario unit
121c Transmission unit
122 Monitoring unit
123 Log analysis unit

1. A testing device comprising:
access examination circuitry configured to examiner an access method for a plurality of devices existing in a test target network;
test scenario circuitry configured to generate a test packet on a basis of an examination result of the access method and a scenario in which a procedure related to generation of the test packet is described;
a transmitter that transmits the test packet; and
log analysis circuitry configured to collect a log from a device to which the test packet is transmitted among the plurality of devices existing in the test target network and analyzes the collected log.

2. The testing device according to claim 1, wherein:
the access examination circuitry performs processing of examining whether it is possible to establish a transmission control protocol (TCP) connection by performing a three-way handshake on IP addresses included in an IP address range of the test target network, and recording an IP address capable of establishing the TCP connection in an IP address table.

3. The testing device according to claim 2, wherein:
the access examination circuitry performs processing of extracting a uniform resource locator (URL) corresponding to a domain name of an IP address included in the IP address range of the test target network, and recording the extracted URL in a URL table in a case where an IP address of a response packet at a time of accessing the extracted URL is included in the IP address range of the test target network.

4. The testing device according to claim 3, wherein;
the test scenario circuitry establishes a TCP connection on a basis of an IP address recorded in the IP address table and a predetermined destination port number, and generates the test packet by setting the IP address recorded in the IP address table in a hypertext transfer protocol (HTTP) request packet.

5. The testing device according to claim 4, wherein:
in a case where URLs of sites of the plurality of devices existing in the test target network are recorded in the URL table, the test scenario circuitry generates the test packet by setting the URLs recorded in the URL table in the HTTP request packet.

6. The testing device according to claim 1, wherein:
the transmitter transmits the test packet and a packet generated by operation of a web browser to the test target network.

7. The testing device according to claim 1, wherein:
the log analysis circuitry analyzes presence or absence of an increase in a processing load of the device to which the test packet is transmitted and presence or absence of discarding of a normal packet on a basis of the collected log.
